(19) United States
(12) Patent Application Publication
(10) Pub. No.: US 2021/0350006 A1
(43) Pub. Date: Nov. 11, 2021

(54) SYSTEMS AND METHODS FOR IDENTIFYING SOFTWARE VULNERABILITIES IN EMBEDDED DEVICE FIRMWARE

(71) Applicant: NortonLifeLock Inc., Tempe, AZ (US)

(72) Inventors: Johannes Krupp, Antibes (FR); Pierre-Antoine Vervier, Cagnes-sur-Mer (FR); Yun Shen, Bristol (GB)

(21) Appl. No.: 16/870,895

(22) Filed: May 8, 2020

(51) Int. Cl. G06F 21/57; G16Y 30/10; G06F 16/951; G06K 9/62

(52) U.S. Cl. CPC G06F 21/577; G06F 21/572; G06F 2221/033; G06F 16/951; G06K 9/6215; G16Y 30/10

(57) ABSTRACT

The disclosed computer-implemented method for identifying software vulnerabilities in embedded device firmware may include (i) collecting a firmware image for an Internet-of-Things device, (ii) extracting library dependencies from the firmware image for the Internet-of-Things device, (iii) identifying a true version of a library specified in the firmware image by checking a ground truth database that records confirmed values for true versions for previously encountered libraries, and (iv) performing a security action to protect a user from a security risk based on identifying the true version of the library specified in the firmware image. Various other methods, systems, and computer-readable media are also disclosed.

### BACKGROUND

Embedded systems may be bundled with statically and dynamically linked libraries. These libraries may optionally be open source. The libraries may also contain vulnerabilities. The vulnerable libraries may be exploited by malicious actors to take control of end-user systems. For example, Internet-of-Things botnets may take advantage of multiple different vulnerabilities that affect Internet-of-Things device firmware to exploit and take over devices. As a result, for many of these botnets the choice of exploiting a particular device solely depends upon the presence of vulnerabilities affecting this device.

The identification of vulnerable linked libraries becomes even more critical with the rise of consumer off-the-shelf Internet-of-Things devices as instances of firmware shipped with these devices often share many libraries to perform different tasks. These tasks may optionally include web applications, image processing, kernel drivers, etc. With the tendency of manufacturers to reuse the same firmware images, with perhaps only minor changes at the application layer, across multiple device types, and with the tendency to take development shortcuts, once one of these libraries is deemed vulnerable it can potentially impact a large number of device types and brands. The present disclosure, therefore, identifies and addresses a need for systems and methods for identifying software vulnerabilities in embedded device firmware.

### SUMMARY

As will be described in greater detail below, the present disclosure describes various systems and methods for identifying software vulnerabilities in embedded device firmware. In one example, a computer-implemented method for protecting users may include (i) collecting a firmware image for an Internet-of-Things device, (ii) extracting library dependencies from the firmware image for the Internet-of-Things device, (iii) identifying a true version of a library specified in the firmware image by checking a ground truth database that records confirmed values for true versions for previously encountered libraries, and (iv) performing a security action to protect a user from a security risk based on identifying the true version of the library specified in the firmware image.

In one embodiment, the firmware image for the Internet-of-Things device is collected from a vendor website. In one embodiment, the firmware image for the Internet-of-Things device is collected from the vendor website using a screen scraping component. In one embodiment, the firmware image for the Internet-of-Things device is collected from the vendor website by a web crawler using the screen scraping component.

In some examples, extracting the library dependencies from the firmware image for the Internet-of-Things device may include extracting the library dependencies from entries within a program file header. In one embodiment, the entries within the program file header identify libraries requested by a corresponding program file. In one embodiment, the ground truth database is generated at least in part by collecting from public repositories binary distributions of libraries that are labeled with true versions. In one embodiment, the ground truth database is generated at least in part by collecting source code distributions.

In some examples, identifying the true version of the library specified in the firmware image by checking the ground truth database may include: (i) extracting a set of exported symbols for the library specified in the firmware image, (ii) checking the extracted set of exported symbols against a list of sets of symbols produced for the previously encountered libraries, respectively, according to the ground truth database, and (iii) identifying a match between the set of exported symbols for the library specified in the firmware image and an entry in the list of sets of symbols produced for the previously encountered libraries. In one embodiment, the security action may include comparing a release date for the firmware image against a release date for the true version of the library specified in the firmware image to give an indication of how well-maintained the Internet-of-Things device is.

In one embodiment, a system for implementing the above-described method may include (i) a collection module, stored in memory, that collects a firmware image for an Internet-of-Things device, (ii) an extraction module, stored in memory, that extracts library dependencies from the firmware image for the Internet-of-Things device, (iii) an identification module, stored in memory, that identifies a true version of a library specified in the firmware image by checking a ground truth database that records confirmed values for true versions for previously encountered libraries, (iv) a performance module, stored in memory, that performs a security action to protect a user from a security risk based on identifying the true version of the library specified in the firmware image, and (v) at least one physical processor configured to execute the collection module, the extraction module, the identification module, and the performance module.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to (i) collect a firmware image for an Internet-of-Things device, (ii) extract library dependencies from the firmware image for the Internet-of-Things device, (iii) identify a true version of a library specified in the firmware image by checking a ground truth database that records confirmed values for true versions for previously encountered libraries, and (iv) perform a security action to protect a user from a security risk based on identifying the true version of the library specified in the firmware image.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for identifying software vulnerabilities in embedded device firmware.

FIG. 2 is a block diagram of an additional example system for identifying software vulnerabilities in embedded device firmware.

FIG. 3 is a flow diagram of an example method for identifying software vulnerabilities in embedded device firmware.

FIG. 4 is a block diagram of an example database.

FIG. 5 is a block diagram of an example computing system capable of implementing one or more of the embodiments described and/or illustrated herein.

FIG. 6 is a block diagram of an example computing network capable of implementing one or more of the embodiments described and/or illustrated herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure is generally directed to systems and methods for identifying software vulnerabilities in embedded device firmware. Generally speaking, the disclosed subject matter may improve upon related systems by improving the accuracy or efficiency of identifying version numbers for corresponding libraries within Internet-of-Things devices and corresponding firmware. Accurately and efficiently identifying the version numbers may enable a corresponding security system to protect the user from vulnerabilities that are associated with specific versions of these libraries. Accurately and efficiently identifying the version numbers may also enable the security system to gauge or measure how well-maintained the Internet-of-Things device is from a security perspective.

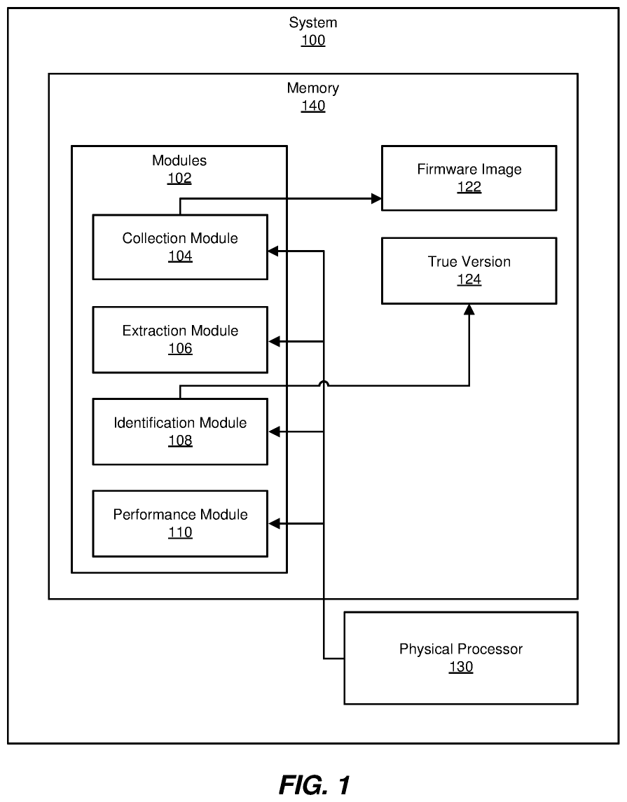

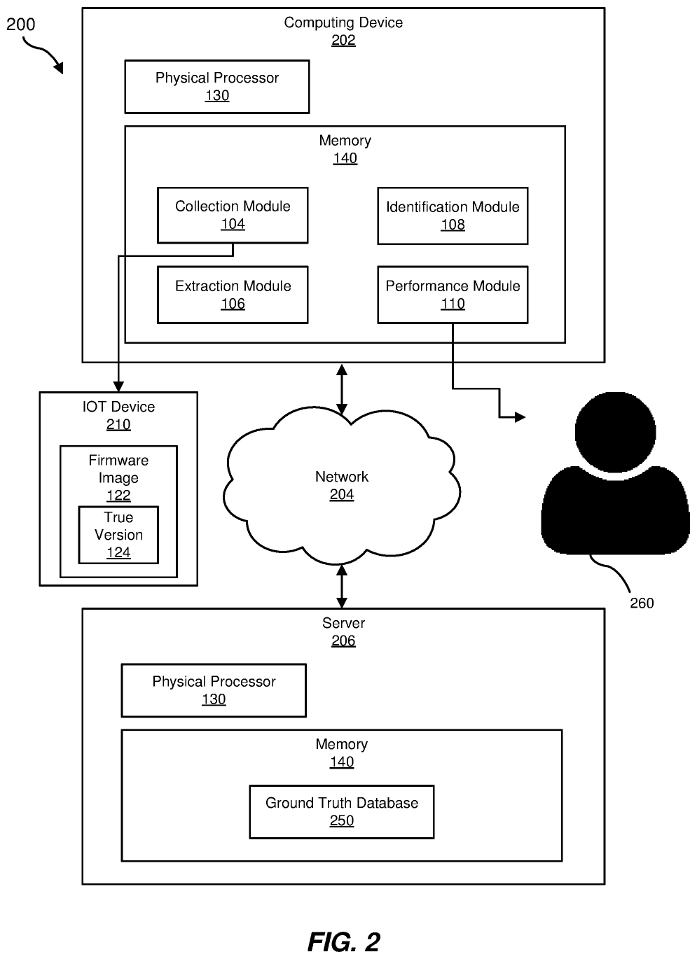

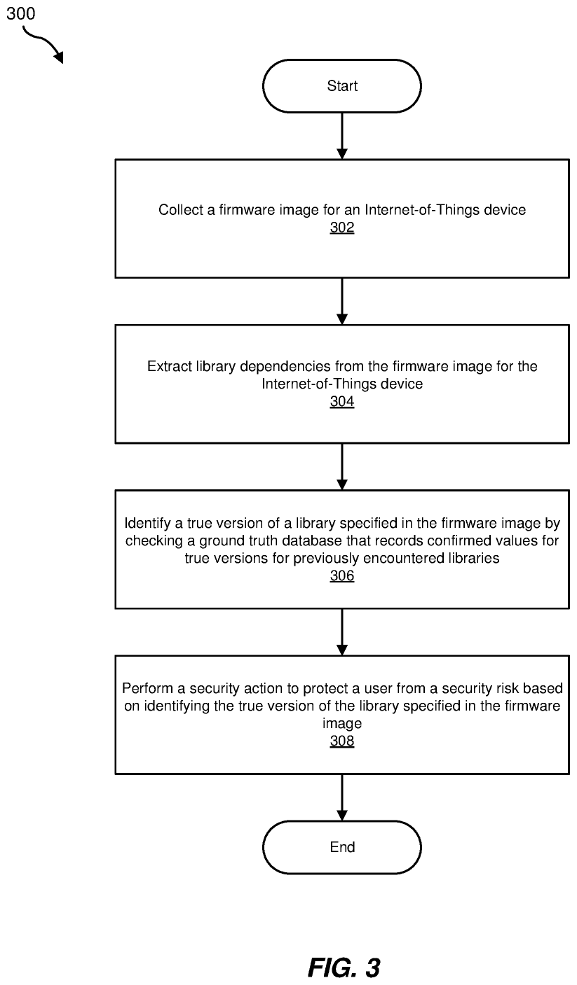

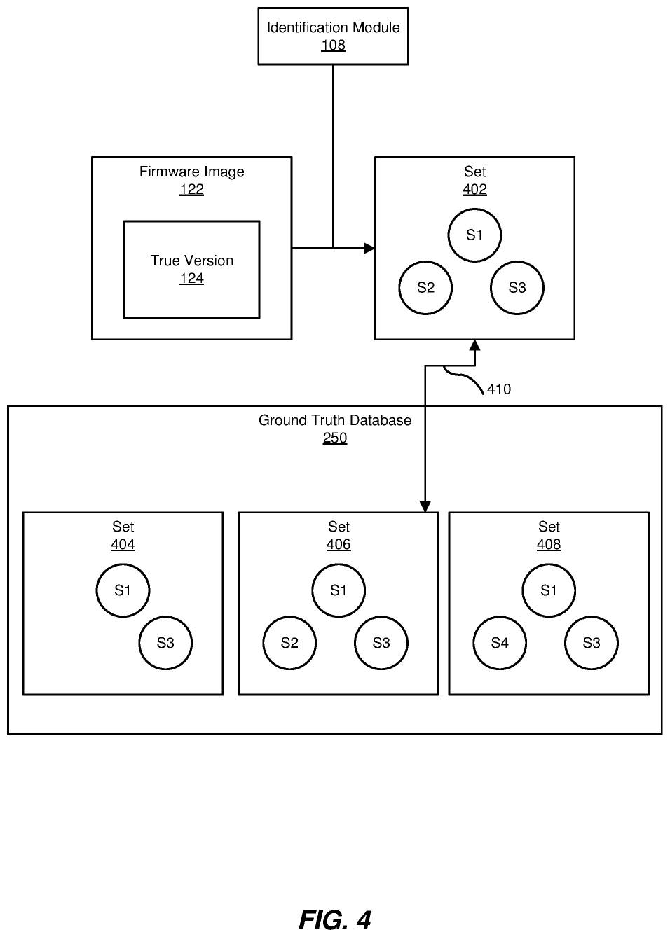

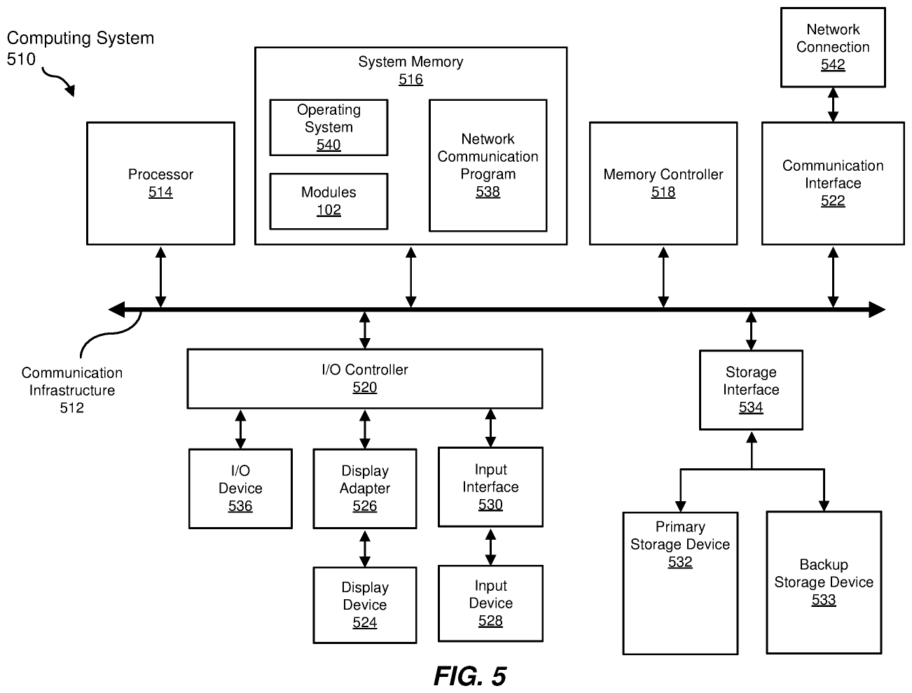

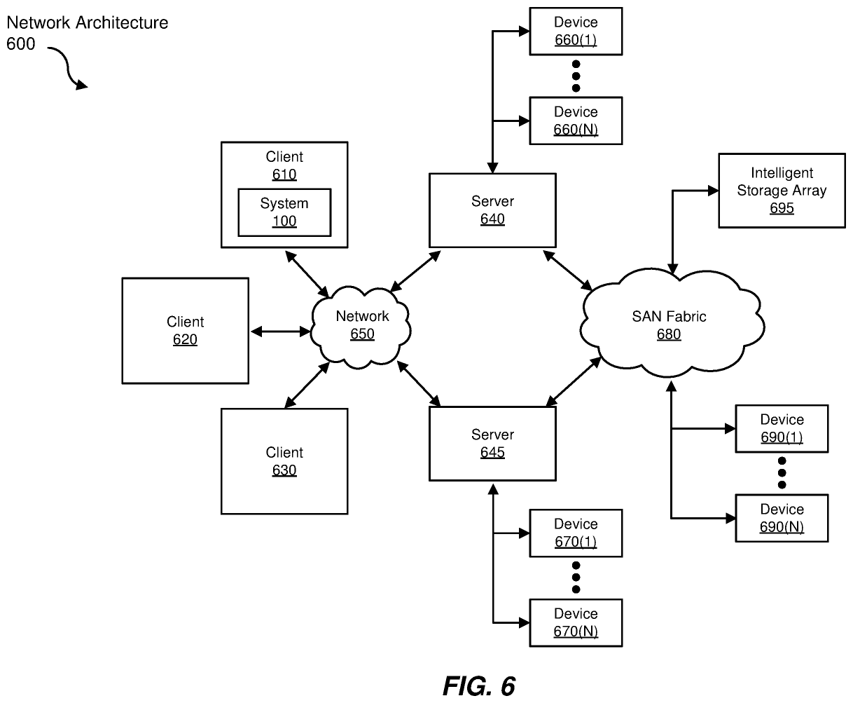

The following will provide, with reference to FIGS. 1-2, detailed descriptions of example systems for identifying software vulnerabilities in embedded device firmware. Detailed descriptions of corresponding computer-implemented methods will also be provided in connection with FIGS. 3-4. In addition, detailed descriptions of an example computing system and network architecture capable of implementing one or more of the embodiments described herein will be provided in connection with FIGS. 5 and 6, respectively.

FIG. 1 is a block diagram of example system 100 for protecting users. As illustrated in this figure, example system 100 may include one or more modules 102 for performing one or more tasks. For example, and as will be explained in greater detail below, example system 100 may include a collection module 104 that collects a firmware image, such as a firmware image 122, for an Internet-of-Things device. Example system 100 may additionally include an extraction module 106 that extracts library dependencies from the firmware image for the Internet-of-Things device. Example system 100 may also include an identification module 108 that identifies a true version, such as a true version 124, of a library specified in the firmware image by checking a ground truth database that records confirmed values for true versions for previously encountered libraries. Example system 100 may additionally include a performance module 110 that performs a security action to protect a user from a security risk based on identifying the true version of the library specified in the firmware image. Although illustrated as separate elements, one or more of modules 102 in FIG. 1 may represent portions of a single module or application.

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 206). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate identifying software vulnerabilities in embedded device firmware. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Example system 100 in FIG. 1 may be implemented in a variety of ways. For example, all or a portion of example system 100 may represent portions of example system 200 in FIG. 2. As shown in FIG. 2, system 200 may include a computing device 202 in communication with a server 206 via a network 204. In one example, all or a portion of the functionality of modules 102 may be performed by computing device 202, server 206, and/or any other suitable computing system.

Computing device 202 generally represents any type or form of computing device capable of reading computer-executable instructions. In some examples, computing device 202 may correspond to any computing device that may successfully perform method 300 of FIG. 3 to protect a user. Additional examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

Server 206 generally represents any type or form of computing device that is capable of facilitating the performance of method 300 in coordination with computing device 202. Additional examples of server 206 include, without limitation, security servers, application servers, web servers, storage servers, and/or database servers configured to run certain software applications and/or provide various security, web, storage, and/or database services. Although illustrated as a single entity in FIG. 2, server 206 may include and/or represent a plurality of servers that work and/or operate in conjunction with one another.

Network 204 generally represents any medium or architecture capable of facilitating communication or data transfer. In one example, network 204 may facilitate communication between computing device 202 and server 206. In this example, network 204 may facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

FIG. 3 is a flow diagram of an example computer-implemented method 300 for identifying software vulnerabilities in embedded device firmware. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 302, one or more of the systems described herein may collect a firmware image for an Internet-of-Things device. For example, collection module 104 may, as part of computing device 202 in FIG. 2, collect firmware image 122 for an Internet-of-Things device 210.

Collection module 104 may collect the firmware image for the Internet-of-Things device in a variety of ways. In some examples, collection module 104 may collect the firmware image for the Internet-of-Things device as part of a batch process for collecting a multitude of firmware images for multiple different respective Internet-of-Things devices.

In one embodiment, the firmware image for the Internet-of-Things device is collected from a vendor website. In further examples, collection module 104 may collect the firmware image for the Internet-of-Things device from the vendor website using a screen scraping component. Additionally, or alternatively, collection module 104 may, as part of a web crawler or in coordination with a web crawler, collect the firmware image for the Internet-of-Things device from the vendor website at least in part by crawling to the vendor website. One illustrative example of such a screen scraping component may include SCRAPY.

In some examples, when using a screen scraping component, collection module 104 may also optionally apply one or more vendor-specific plug-ins. The vendor-specific plug-ins may enable collection module 104 to parse, and successfully extract, the firmware image for the Internet-of-Things device. For example, the vendor-specific plug-in may provide collection module 104 with information indicating to collection module 104 how to successfully read, and download firmware images from, a corresponding vendor website.

In some examples, the collection of firmware images collected by collection module 104 may include raw firmware images and/or additional metadata. The additional metadata may optionally specify values of information such as a release date and/or such as version numbers.

Collection module 104 may also optionally engage in a pre-processing stage with respect to the firmware image for the Internet-of-Things device. Collection module 104 may perform the pre-processing stage at least in part by unpacking the firmware image by extracting one or more binary files. The unpacking procedure may be based on a software tool that enables one to search a given binary image for embedded files and/or executable code. One illustrative example of such a software tool may include BINWALK, which enables one to successfully read, browse, parse, and/or extract information from a binary image. In addition to applying the software tool, such as BINWALK, collection module 104 may also optionally apply one or more additional patches, which may improve an overall success rate.

As a concluding part of the pre-processing stage, collection module 104 may optionally identify one or more binary files in the unpacked firmware image. Collection module 104 may identify the binary files by checking one or more of the corresponding magic numbers against an ELF signature (EXECUTABLE AND LINKABLE FORMAT signature).

At step 304, one or more of the systems described herein may extract library dependencies from the firmware image for the Internet-of-Things device. For example, extraction module 106 may, as part of computing device 202 in FIG. 2, extract library dependencies from firmware image 122 for Internet-of-Things device 210.

Extraction module 106 may perform step 304 in a variety of ways. For example, extraction module 106 may optionally extract the library dependencies from the firmware image for the Internet-of-Things device by extracting the library dependencies from entries within a program file header.

Optionally, extraction module 106 may, after one or more binary files have been identified, extract static and/or dynamically linked library dependencies. Extraction module 106 may extract these dependencies from header information. For example, in the context of dynamically linked libraries, corresponding entries within a header may include DT_NEEDED entries. Such entries may specify that one or more library files is requested or required to successfully compile or execute the corresponding program file.

In some examples, the unpacking procedure performed by collection module 104 and/or extraction module 106 may fail to restore an exact file system structure. For example, collection module 104 may unpack the firmware image and fail to restore the exact file system structure due to missing mount information. To overcome this deficiency, or otherwise compensate for this deficiency, extraction module 106 may optionally identify names that are specified within header entries, such as DT_NEEDED entries. Extraction module 106 may also optionally search over the entire unpacked firmware package for one or more detected instances of these names that were specified within the header entries. Similarly, any symbolic links that may have been encountered during library identification may be resolved by extraction module 106 in a parallel manner to that described above regarding the header entries.

At step 306, one or more of the systems described herein may identify a true version of a library specified in the firmware image by checking a ground truth database that records confirmed values for true versions for previously encountered libraries. For example, identification module 108 may, as part of computing device 202 in FIG. 2, identify true version 124 of a library specified in firmware image 122 by checking a ground truth database 250 that records confirmed values for true versions for previously encountered libraries.

Identification module 108 may identify the true value for the version of the library specified in the firmware image in a variety of ways. In particular, to pinpoint the true version of the library identified in the firmware image, identification module 108 may first obtain, or access, a ground truth database. In some examples, identification module 108 may obtain or access the ground truth database at least in part by generating the ground truth database.

Generally speaking, identification module 108 may optionally leverage the ground truth database to build, access, or reference a symbol database. In some examples, the ground truth database may include the symbol database. The symbol database may optionally list the sets of symbols of each and every library version previously encountered and recorded within the corresponding database. When identifying the true version of a newly encountered library, or unknown library, a set of exported symbols for the newly encountered library may be extracted in a parallel manner. Accordingly, identification module 108 may compare the newly extracted set of exported symbols for the version of the unknown library and then compare the newly extracted set to the symbol database in an attempt to ascertain and identify a match.

In some examples, identification module 108 may detect a match by calculating a measurement of Jaccard similarity, such as a Jaccard index or Jaccard distance. In these examples, identification module 108 may optionally compare the measurement of similarity against a corresponding threshold that specifies a level of similarity over which a newly encountered library is considered a match for one of the previously encountered libraries recorded within the corresponding database.

In one embodiment, the ground truth database is generated at least in part by collecting from public repositories binary distributions of libraries that are labeled with true versions. Additionally, or alternatively, the ground truth database is generated at least in part by collecting source code distributions. In further examples, identification module 108 may optionally generate part or all of the ground truth database, including optionally the symbol database.

In more general terms, identification module 108 may identify the true version of the library specified in the firmware image by performing a series of steps with respect to the ground truth database. First, identification module 108 may optionally extract a set of exported symbols for the library specified in the firmware image. Second, identification module 108 may optionally check the extracted set of exported symbols against a list of sets of symbols produced for the previously encountered libraries, respectively, according to the ground truth database. Lastly, identification module 108 may also optionally identify a match between the set of exported symbols for the library specified in the firmware image and an entry in the list of sets of symbols produced for the previously encountered libraries.

FIG. 4 shows an illustrative example of ground truth database 250 and a workflow that corresponds to step 306 of method 300. As further shown in this figure, identification module 108 may identify a match 410 between a set 402 and a set 406. Set 402 may correspond to a set of exported symbols generated by a newly encountered library as part of firmware image 122. In other words, modules 102 may have encountered a new library instance requested by the firmware of an Internet-of-Things device. In order to help pinpoint a specific and accurate version number for the library, identification module 108 may optionally generate a list of exported symbols that the newly encountered library produces.

As used herein, the term “symbol” may generally refer to an alphanumeric or other character string that uniquely identifies a function that is made accessible through a corresponding library. Generally speaking, the list of symbols produced by a corresponding library may map, in a one-to-one mapping, with each and all of the functions made accessible through the library. In other words, each symbol may uniquely identify a corresponding function. In some examples, each symbol may correspond to, or include, an ordinal value in the context of library and executable files.

In contrast, ground truth database 250 may include data identifying previously encountered versions of libraries, including information indicating the identity or name of each library, the value for the version of each instance of each library (e.g., a confirmed or verified version value), and/or a corresponding set of exported symbols produced by each respective version of the library recorded within the ground truth database (e.g., for each library-version pair there is a corresponding set of exported symbols). In the example of FIG. 4, ground truth database 250 includes three separate sets, set 404, set 406, and set 408, which correspond to three separate library-version pairs that were previously encountered and recorded within ground truth database 250. Moreover, as shown in this figure, identification module 108 may identify a match between set 402 and set 406, thereby further indicating that the newly encountered library at step 306 matches the library corresponding to set 406 that was previously encountered and recorded within ground truth database 250. Accordingly, identification module 108 may first detect this match between set 402 and set 406. Identification module 108 may subsequently ascertain the verified version value for set 406. Identification module 108 may then apply or propagate the verified version value for set 406 to set 402 in the newly encountered library discussed above in connection with step 306. In contrast, set 402 does not match either set 404 or set 408 (i.e., because set 404 does not include symbol S2 and because set 408 includes symbol S4 rather than symbol S2).

At step 308, one or more of the systems described herein may perform a security action to protect a user from a security risk based on identifying the true version of the library specified in the firmware image. For example, performance module 110 may, as part of computing device 202 in FIG. 2, perform a security action to protect a user from a security risk based on identifying the true version of the library specified in the firmware image.

Performance module 110 may perform the security action in a variety of ways. In some examples, the security action may include comparing a release date for the firmware image against a release date for the true version of the library specified in the firmware image to give an indication of how well-maintained the Internet-of-Things device is. In these examples, performance module 110 may thereby obtain a measurement of how well-maintained the corresponding product is. Accordingly, performance module 110 may also optionally inform a user or administrator, such as a user 260 shown in FIG. 2, about the measured degree of maintenance, thereby helping to inform the user or administrator about a potential security risk that may be associated with products that are not well-maintained from a security perspective.

Additionally, or alternatively, performance module 110 may also optionally perform the security action at least in part by checking the true version for the library against one or more vulnerability databases. Such vulnerability databases may specify known vulnerabilities for corresponding versions of libraries. Accordingly, performance module 110 may check, and confirm, that the true version of the library has at least one known vulnerability that was previously recorded within a corresponding vulnerability database. In this manner, the user or administrator associated with the Internet-of-Things device may be informed about a security risk and potentially perform one or more remedial actions to protect himself or herself from this risk.

The above discussion provided a general overview of the disclosed systems and methods in the context of method 300 shown in FIG. 3. Additionally, or alternatively, the following discussion provides a detailed overview of concrete embodiments of the disclosed subject matter.

Internet-of-Things devices may often be bundled with libraries, including open source libraries, that contain vulnerabilities. Most Internet-of-Things botnets are packaged with exploits. Packaging the botnets with exploits may generate multitudes of vulnerabilities. The botnets may also be updated as new vulnerabilities are discovered. This updating procedure may provide the primary Internet-of-Things device infection mechanism that poses a security threat today.

In some examples, vulnerable libraries may be reused across a wide range of devices. Such a range of devices may include open-source libraries, software development kits, white-label brands, etc. Reusing the vulnerable libraries across a wide range of devices may increase the impact of these vulnerabilities and corresponding exploits.

One approach to address related problems is based on dynamic analysis. In this approach, real Internet-of-Things device/firmware emulation is performed. Additionally, fuzzing of values is also performed. Unfortunately, this approach generally involves or requires executing or operating corresponding Internet-of-Things devices.

A second approach to address related problems is based on static analysis. In this approach, static analysis and/or symbolic execution is performed on candidate code that is being evaluated. Importantly, this second approach is tedious, prone to false positives, and also potentially involves or requires access to corresponding source code.

Similarly, within the second approach, a security analyst may search for vulnerable code inside of the firmware image by performing a binary DIFF operation. Unfortunately, this variant of the second approach may be limited to one or two libraries due to the amount of manual work that would be involved. In particular, the second approach in this aspect may involve compiling libraries with all possible compilation parameters, etc.

To improve upon such approaches, this application discloses systems and methods that may extract static and/or dynamically linked libraries. The subject matter of this application may also identify true versions for these libraries. The subject matter of this application may use a symbol-based version identification procedure, as further discussed above. Use of the symbol-based version identification may avoid costly binary DIFF operations, which may preferably be reserved as a last resort. Use of the symbol-based version identification may also increase accuracy, and enable scaling to hundreds of libraries. Use of the symbol-based version identification may also only involve one binary per library version. This approach may also enable a security vendor to focus on libraries that are actually used with real Internet-of-Things device firmware.

One approach disclosed within this application may begin with firmware collection and unpacking. In this example, an Internet-of-Things device vendor website may be scraped by a program such as a web crawler using a screen scraping component. Accordingly, the program may extract annotated firmware images, which may specify optionally metadata including a product, version, release date, etc. This approach may proceed with an enhanced version of BINWALK-based unpacking. In some examples, this improved approach to identifying versions of libraries may focus on LINUX-based firmware.

After successfully collecting firmware images, the subject matter of this application may extract libraries within the firmware images. Dynamically linked libraries may be identified through corresponding header entries, such as DT-ENTRIES. The disclosed systems and methods may leverage these header entries to identify and/or download corresponding library binaries.

Additionally, or alternatively, libraries that are identified through static linking may be extracted using heuristic-based user-code or library boundary identification. In other words, the disclosed subject matter may search for instances of known libraries in statically linked binaries and thereby successfully infer corresponding boundaries.

Subsequently, the disclosed subject matter may identify the true version of the newly encountered library. To set this up, the disclosed subject matter may collect binary distributions of libraries or source code. In these examples, one binary per version may be sufficient to successfully identify the true versions of newly encountered libraries. From this collected data, the disclosed subject matter may generate a ground truth database of symbols exported by each library (e.g., by each library-version instance). In particular, the disclosed subject matter may compute a Jaccard distance between libraries in firmware images and the ground truth database, and the disclosed subject matter may evaluate perfect or sufficient matches, as further discussed above.

Lastly, as a security action to protect a corresponding user, administrator, or customer, the disclosed subject matter may correlate extracted libraries with a database of known vulnerabilities in previously encountered library version instances. Additionally, or alternatively, the disclosed subject matter may enable a user or security analyst to successfully study an Internet-of-Things device vendor's development/maintenance practices, where slower or less secure maintenance may be brought to the attention of a potential user or customer to protect them from corresponding security risks.

FIG. 5 is a block diagram of an example computing system 510 capable of implementing one or more of the embodiments described and/or illustrated herein. For example, all or a portion of computing system 510 may perform and/or be a means for performing, either alone or in combination with other elements, one or more of the steps described herein (such as one or more of the steps illustrated in FIG. 3). All or a portion of computing system 510 may also perform and/or be a means for performing any other steps, methods, or processes described and/or illustrated herein.

Computing system 510 broadly represents any single or multi-processor computing device or system capable of executing computer-readable instructions. Examples of computing system 510 include, without limitation, workstations, laptops, client-side terminals, servers, distributed computing systems, handheld devices, or any other computing system or device. In its most basic configuration, computing system 510 may include at least one processor 514 and a system memory 516.

Processor 514 generally represents any type or form of physical processing unit (e.g., a hardware-implemented central processing unit) capable of processing data or interpreting and executing instructions. In certain embodiments, processor 514 may receive instructions from a software application or module. These instructions may cause processor 514 to perform the functions of one or more of the example embodiments described and/or illustrated herein.

System memory 516 generally represents any type or form of volatile or non-volatile storage device or medium capable of storing data and/or other computer-readable instructions. Examples of system memory 516 include, without limitation, Random Access Memory (RAM), Read Only Memory (ROM), flash memory, or any other suitable memory device. Although not required, in certain embodiments computing system 510 may include both a volatile memory unit (such as, for example, system memory 516) and a non-volatile storage device (such as, for example, primary storage device 532, as described in detail below). In one example, one or more of modules 102 from FIG. 1 may be loaded into system memory 516.

In some examples, system memory 516 may store and/or load an operating system 540 for execution by processor 514. In one example, operating system 540 may include and/or represent software that manages computer hardware and software resources and/or provides common services to computer programs and/or applications on computing system 510. Examples of operating system 540 include, without limitation, LINUX, JUNOS, MICROSOFT WINDOWS, WINDOWS MOBILE, MAC OS, APPLE'S 10S, UNIX, GOOGLE CHROME OS, GOOGLE'S ANDROID, SOLARIS, variations of one or more of the same, and/or any other suitable operating system.

In certain embodiments, example computing system 510 may also include one or more components or elements in addition to processor 514 and system memory 516. For example, as illustrated in FIG. 5, computing system 510 may include a memory controller 518, an Input/Output (I/O) controller 520, and a communication interface 522, each of which may be interconnected via a communication infrastructure 512. Communication infrastructure 512 generally represents any type or form of infrastructure capable of facilitating communication between one or more components of a computing device. Examples of communication infrastructure 512 include, without limitation, a communication bus (such as an Industry Standard Architecture (ISA), Peripheral Component Interconnect (PCI), PCI Express (PCIe), or similar bus) and a network.

Memory controller 518 generally represents any type or form of device capable of handling memory or data or controlling communication between one or more components of computing system 510. For example, in certain embodiments memory controller 518 may control communication between processor 514, system memory 516, and I/O controller 520 via communication infrastructure 512.

I/O controller 520 generally represents any type or form of module capable of coordinating and/or controlling the input and output functions of a computing device. For example, in certain embodiments I/O controller 520 may control or facilitate transfer of data between one or more elements of computing system 510, such as processor 514, system memory 516, communication interface 522, display adapter 526, input interface 530, and storage interface 534.

As illustrated in FIG. 5, computing system 510 may also include at least one display device 524 coupled to I/O controller 520 via a display adapter 526. Display device 524 generally represents any type or form of device capable of visually displaying information forwarded by display adapter 526. Similarly, display adapter 526 generally represents any type or form of device configured to forward graphics, text, and other data from communication infrastructure 512 (or from a frame buffer, as known in the art) for display on display device 524.

As illustrated in FIG. 5, example computing system 510 may also include at least one input device 528 coupled to I/O controller 520 via an input interface 530. Input device 528 generally represents any type or form of input device capable of providing input, either computer or human generated, to example computing system 510. Examples of input device 528 include, without limitation, a keyboard, a pointing device, a speech recognition device, variations or combinations of one or more of the same, and/or any other input device.

Additionally or alternatively, example computing system 510 may include additional I/O devices. For example, example computing system 510 may include I/O device 536. In this example, I/O device 536 may include and/or represent a user interface that facilitates human interaction with computing system 510. Examples of I/O device 536 include, without limitation, a computer mouse, a keyboard, a monitor, a printer, a modem, a camera, a scanner, a microphone, a touchscreen device, variations or combinations of one or more of the same, and/or any other I/O device.

Communication interface 522 broadly represents any type or form of communication device or adapter capable of facilitating communication between example computing system 510 and one or more additional devices. For example, in certain embodiments communication interface 522 may facilitate communication between computing system 510 and a private or public network including additional computing systems. Examples of communication interface 522 include, without limitation, a wired network interface (such as a network interface card), a wireless network interface (such as a wireless network interface card), a modem, and any other suitable interface. In at least one embodiment, communication interface 522 may provide a direct connection to a remote server via a direct link to a network, such as the Internet. Communication interface 522 may also indirectly provide such a connection through, for example, a local area network (such as an Ethernet network), a personal area network, a telephone or cable network, a cellular telephone connection, a satellite data connection, or any other suitable connection.

In certain embodiments, communication interface 522 may also represent a host adapter configured to facilitate communication between computing system 510 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 522 may also allow computing system 510 to engage in distributed or remote computing. For example, communication interface 522 may receive instructions from a remote device or send instructions to a remote device for execution.

In some examples, system memory 516 may store and/or load a network communication program 538 for execution by processor 514. In one example, network communication program 538 may include and/or represent software that enables computing system 510 to establish a network connection 542 with another computing system (not illustrated in FIG. 5) and/or communicate with the other computing system by way of communication interface 522. In this example, network communication program 538 may direct the flow of outgoing traffic that is sent to the other computing system via network connection 542. Additionally or alternatively, network communication program 538 may direct the processing of incoming traffic that is received from the other computing system via network connection 542 in connection with processor 514.

Although not illustrated in this way in FIG. 5, network communication program 538 may alternatively be stored and/or loaded in communication interface 522. For example, network communication program 538 may include and/or represent at least a portion of software and/or firmware that is executed by a processor and/or Application Specific Integrated Circuit (ASIC) incorporated in communication interface 522.

As illustrated in FIG. 5, example computing system 510 may also include a primary storage device 532 and a backup storage device 533 coupled to communication infrastructure 512 via a storage interface 534. Storage devices 532 and 533 generally represent any type or form of storage device or medium capable of storing data and/or other computer-readable instructions. For example, storage devices 532 and 533 may be a magnetic disk drive (e.g., a so-called hard drive), a solid state drive, a floppy disk drive, a magnetic tape drive, an optical disk drive, a flash drive, or the like. Storage interface 534 generally represents any type or form of interface or device for transferring data between storage devices 532 and 533 and other components of computing system 510.

In certain embodiments, storage devices 532 and 533 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 532 and 533 may also include other similar structures or devices for allowing computer software, data, or other computer-readable instructions to be loaded into computing system 510. For example, storage devices 532 and 533 may be configured to read and write software, data, or other computer-readable information. Storage devices 532 and 533 may also be a part of computing system 510 or may be a separate device accessed through other interface systems.

Many other devices or subsystems may be connected to computing system 510. Conversely, all of the components and devices illustrated in FIG. 5 need not be present to practice the embodiments described and/or illustrated herein. The devices and subsystems referenced above may also be interconnected in different ways from that shown in FIG. 5. Computing system 510 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 510. All or a portion of the computer program stored on the computer-readable medium may then be stored in system memory 516 and/or various portions of storage devices 532 and 533. When executed by processor 514, a computer program loaded into computing system 510 may cause processor 514 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 510 may be configured as an Application Specific Integrated Circuit (ASIC) adapted to implement one or more of the example embodiments disclosed herein.

FIG. 6 is a block diagram of an example network architecture 600 in which client systems 610, 620, and 630 and servers 640 and 645 may be coupled to a network 650. As detailed above, all or a portion of network architecture 600 may perform and/or be a means for performing, either alone or in combination with other elements, one or more of the steps disclosed herein (such as one or more of the steps illustrated in FIG. 3). All or a portion of network architecture 600 may also be used to perform and/or be a means for performing other steps and features set forth in the present disclosure.

Client systems 610, 620, and 630 generally represent any type or form of computing device or system, such as example computing system 510 in FIG. 5. Similarly, servers 640 and 645 generally represent computing devices or systems, such as application servers or database servers, configured to provide various database services and/or run certain software applications. Network 650 generally represents any telecommunication or computer network including, for example, an intranet, a WAN, a LAN, a PAN, or the Internet. In one example, client systems 610, 620, and/or 630 and/or servers 640 and/or 645 may include all or a portion of system 100 from FIG. 1.

As illustrated in FIG. 6, one or more storage devices 660(1)-(N) may be directly attached to server 640. Similarly, one or more storage devices 670(1)-(N) may be directly attached to server 645. Storage devices 660(1)-(N) and storage devices 670(1)-(N) generally represent any type or form of storage device or medium capable of storing data and/or other computer-readable instructions. In certain embodiments, storage devices 660(1)-(N) and storage devices 670(1)-(N) may represent Network-Attached Storage (NAS) devices configured to communicate with servers 640 and 645 using various protocols, such as Network File System (NFS), Server Message Block (SMB), or Common Internet File System (CIFS).

Servers 640 and 645 may also be connected to a Storage Area Network (SAN) fabric 680. SAN fabric 680 generally represents any type or form of computer network or architecture capable of facilitating communication between a plurality of storage devices. SAN fabric 680 may facilitate communication between servers 640 and 645 and a plurality of storage devices 690(1)-(N) and/or an intelligent storage array 695. SAN fabric 680 may also facilitate, via network 650 and servers 640 and 645, communication between client systems 610, 620, and 630 and storage devices 690(1)-(N) and/or intelligent storage array 695 in such a manner that devices 690(1)-(N) and array 695 appear as locally attached devices to client systems 610, 620, and 630. As with storage devices 660(1)-(N) and storage devices 670(1)-(N), storage devices 690(1)-(N) and intelligent storage array 695 generally represent any type or form of storage device or medium capable of storing data and/or other computer-readable instructions.

In certain embodiments, and with reference to example computing system 510 of FIG. 5, a communication interface, such as communication interface 522 in FIG. 5, may be used to provide connectivity between each client system 610, 620, and 630 and network 650. Client systems 610, 620, and 630 may be able to access information on server 640 or 645 using, for example, a web browser or other client software. Such software may allow client systems 610, 620, and 630 to access data hosted by server 640, server 645, storage devices 660(1)-(N), storage devices 670(1)-(N), storage devices 690(1)-(N), or intelligent storage array 695. Although FIG. 6 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 640, server 645, storage devices 660(1)-(N), storage devices 670(1)-(N), storage devices 690(1)-(N), intelligent storage array 695, or any combination thereof. All or a portion of one or more of the example embodiments disclosed herein may also be encoded as a computer program, stored in server 640, run by server 645, and distributed to client systems 610, 620, and 630 over network 650.

As detailed above, computing system 510 and/or one or more components of network architecture 600 may perform and/or be a means for performing, either alone or in combination with other elements, one or more steps of an example method for identifying software vulnerabilities in embedded device firmware.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of example system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of example system 100 in FIG. 1 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of example system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smart watches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of example system 100 in FIG. 1 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of example system 100 in FIG. 1 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of example system 100 in FIG. 1 may represent portions of, communicate with, and/or receive protection from one or more systems for endpoint security. As used herein, the term “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for identifying software vulnerabilities in embedded device firmware, at least a portion of the method being performed by a computing device comprising at least one processor, the method comprising:
collecting a firmware image for an Internet-of-Things device;
extracting library dependencies from the firmware image for the Internet-of-Things device;
identifying a true version of a library specified in the firmware image by checking a ground truth database that records confirmed values for true versions for previously encountered libraries; and
performing a security action to protect a user from a security risk based on identifying the true version of the library specified in the firmware image.

2. The computer-implemented method of claim 1, wherein the firmware image for the Internet-of-Things device is collected from a vendor website.

3. The computer-implemented method of claim 2, wherein the firmware image for the Internet-of-Things device is collected from the vendor website using a screen scraping component.

4. The computer-implemented method of claim 3, wherein the firmware image for the Internet-of-Things device is collected from the vendor website by a web crawler using the screen scraping component.

5. The computer-implemented method of claim 1, wherein extracting the library dependencies from the firmware image for the Internet-of-Things device comprises extracting the library dependencies from entries within a program file header.

6. The computer-implemented method of claim 5, wherein the entries within the program file header identify libraries requested by a corresponding program file.

7. The computer-implemented method of claim 1, wherein the ground truth database is generated at least in part by collecting from public repositories binary distributions of libraries that are labeled with true versions.

8. The computer-implemented method of claim 1, wherein the ground truth database is generated at least in part by collecting source code distributions.

9. The computer-implemented method of claim 1, wherein identifying the true version of the library specified in the firmware image by checking the ground truth database comprises:
extracting a set of exported symbols for the library specified in the firmware image;
checking the extracted set of exported symbols against a list of sets of symbols produced for the previously encountered libraries, respectively, according to the ground truth database; and
identifying a match between the set of exported symbols for the library specified in the firmware image and an entry in the list of sets of symbols produced for the previously encountered libraries.

10. The computer-implemented method of claim 1, wherein the security action comprises comparing a release date for the firmware image against a release date for the true version of the library specified in the firmware image to give an indication of how well-maintained the Internet-of-Things device is.

11. A system for protecting users, the system comprising:
a collection module, stored in memory, that collects a firmware image for an Internet-of-Things device;
an extraction module, stored in memory, that extracts library dependencies from the firmware image for the Internet-of-Things device;
an identification module, stored in memory, that identifies a true version of a library specified in the firmware image by checking a ground truth database that records confirmed values for true versions for previously encountered libraries;
a performance module, stored in memory, that performs a security action to protect a user from a security risk based on identifying the true version of the library specified in the firmware image; and
at least one physical processor configured to execute the collection module, the extraction module, the identification module, and the performance module.

12. The system of claim 11, wherein the firmware image for the Internet-of-Things device is collected from a vendor website.

13. The system of claim 12, wherein the collection module is configured to collect the firmware image for the Internet-of-Things device from the vendor website using a screen scraping component.

14. The system of claim 13, wherein the collection module is configured to collect the firmware image for the Internet-of-Things device from the vendor website as part of a web crawler using the screen scraping component.

15. The system of claim 11, wherein the extraction module extracts the library dependencies from the firmware image for the Internet-of-Things device by extracting the library dependencies from entries within a program file header.

16. The system of claim 15, wherein the entries within the program file header identify libraries requested by a corresponding program file.

17. The system of claim 11, wherein the ground truth database is generated at least in part by collecting from public repositories binary distributions of libraries that are labeled with true versions.

18. The system of claim 11, wherein the ground truth database is generated at least in part by collecting source code distributions.

19. The system of claim 11, wherein the identification module identifies the true version of the library specified in the firmware image by checking the ground truth database at least in part by:
extracting a set of exported symbols for the library specified in the firmware image;
checking the extracted set of exported symbols against a list of sets of symbols produced for the previously encountered libraries, respectively, according to the ground truth database; and
identifying a match between the set of exported symbols for the library specified in the firmware image and an entry in the list of sets of symbols produced for the previously encountered libraries.

20. A non-transitory computer-readable medium comprising one or more computer-readable instructions that, when executed by at least one processor of a computing device, cause the computing device to:
collect a firmware image for an Internet-of-Things device;
extract library dependencies from the firmware image for the Internet-of-Things device;
identify a true version of a library specified in the firmware image by checking a ground truth database that records confirmed values for true versions for previously encountered libraries; and
perform a security action to protect a user from a security risk based on identifying the true version of the library specified in the firmware image.
